(19) United States
(12) Patent Application Publication
(10) Pub. No.: US 2014/0237482 A1
(43) Pub. Date: Aug. 21, 2014

(54) COMPUTATIONAL RESOURCE MANAGEMENT

(71) Applicant: cpuMash LLC, Denver, CO (US)

(72) Inventor: James Garvey, Denver, CO (US)

(73) Assignee: cpuMash LLC, Denver, CO (US)

(21) Appl. No.: 14/185,913

(22) Filed: Feb. 20, 2014

Related U.S. Application Data
(60) Provisional application No. 61/767,783, filed on Feb. 21, 2013.

(51) Int. Cl. G06F 9/50

(52) U.S. Cl. CPC G06F 9/5088
USPC 718/105

(57) ABSTRACT

Computational tasks are completed using third-party (user) devices. The tasks are delivered to a computational resource manager (broker) by a task originator. The originator pays a fee to the broker to have the task completed. The broker has a relationship with a content publisher (for web sites or apps) which has users. The publisher inserts inline code in its web page or app supplied by the broker. The code, when executed by the user's browser, enables the broker to communicate with the user. The broker identifies users who have devices that are suitable for completing the task. The task is assigned and executes on that device. When completed, the task output is delivered to the broker who makes it accessible to the task originator. In these processes, user, task originator, and publisher identities are protected. The broker manages the transactions and message passing among the parties.

### CROSS-REFERENCE TO RELATED APPLICATIONS

This application claims priority under U.S.C. §119(e) to pending U.S. Provisional Application No. 61/767,783 filed Feb. 21, 2013, entitled “NOVEL SYSTEMS AND METHODS FOR MANAGING COMPUTATIONAL RESOURCES,” incorporated by reference herein in its entirety.

### BACKGROUND OF THE INVENTION

1. Field of the Invention

The present invention relates to software for managing computational resources for completing tasks on remote user devices. More specifically, it relates to software for obtaining computational tasks from one party and have the tasks completed by computing devices belonging to another party through a broker and publisher.

2. Description of the Related Art

In the current computing technology environment, there are several noticeable trends. One is that personal computing devices, whether they be desktop, laptop, or mobile devices, have been increasing in processing power and will continue to do so. As it is, most personal and home computing power has not been harnessed to its fullest extent. For example, an average person with a limited budget can purchase a desktop computer, laptop computer, tablet or mobile phone that contains a powerful CPU or in some cases multiple CPUs and a vast amount of RAM—yet, most people recognize (or are likely aware) that typical personal computing habits rarely utilize the full capabilities of his or her favorite computing device. This underutilization of computational capacity may be characterized as a resource that has been hidden in plain sight. Typically, most personal computing needs do not need the computational speed and capacity of many of the processors in today's personal computers.

The other trend is more recent and has become known to the public in the last few years. This is the need that enterprises, government institutions, universities, and other entities have to perform computational tasks requiring huge amounts of processing power and involving massive volumes of data. A short-hand way of referring to this trend that has emerged in the media is the term “big data.” This is certainly part of it, but big data is not the complete picture. There are well-known companies, for example, in social media and networking, which have vast reservoirs of data. Incredible processing resources are required to collate, analyze and interpret these vast pools of data. Just a few years ago, it would have been difficult to imagine how any enterprise would could have the capability to make large data sets useful At the same time, there has been a rise in the number of smaller yet computationally intensive tasks by smaller companies that need to be fulfilled. The amount of data is growing in all sectors of society, whether public or private, and there is an increasing appetite to harness this information and make it useful.

Finally, there is a growing acceptance and willingness to share resources, mostly driven by economic factors. There is now sharing in housing, transportation, and computing. With respect to computing, there have been various shared computing solutions that generally operate in the same way: a user needs to explicitly download, install and execute various software packages in order to take part in a distributed computing system. Today's distributed computing systems are private systems where the computational benefits are shared within an organization. However, since the 1990s, there have been multiple academic distributed computing projects that attempt to solve a difficult computational problem by breaking up the problem into smaller pieces that are run on the individual's computer. These projects offer altruistic feelings and colorful visualizations in exchange for the user's computational resources. While these academic projects were available to download to the public, the actual computational benefits were guarded by a select group of individuals within the organization.

Individuals and home users have significant processing resources on their personal computers, tablets and mobile phones that are notably underutilized. Enterprises are getting more and more data and have computational tasks involving these data sources that their current servers cannot handle. This may be oversimplifying the issues faced by enterprises but gets to the core of the problem many of them face. These two trends can be coupled with another challenge presented to many online publishers and mobile app developers, a challenge that at first glance may appear disconnected from these two trends. That is, the challenge that online publishers and app developers are facing of generating revenue that is not tied to advertising. Without getting into detail, many online content providers (such as websites with millions of monthly impressions) and mobile app creators (such as popular apps that are downloaded millions of times for free) are not making the money they would like simply from advertising. For future growth, they need other sources of revenue. As such, it would be desirable to address the enterprises' computational tasks and provide additional revenue streams for publishers and app developers. And to do both while tapping a vastly underutilized resource in a manner that is unobtrusive to the resource owners and beneficial to all parties.

### SUMMARY OF THE INVENTION

Computational tasks are completed using third-party (user) devices, including PCs, laptops, mobile phones, and tablets. The tasks may often be computationally intensive and are delivered to a computational resource manager (broker) by a task originator (originator). The originator pays a fee to the broker to have the task completed. The broker has a relationship with a content publisher, such as a web site operator or an app developer. The publisher has visitors or users who either visit the publisher's web pages or uses the publisher's app. The publisher inserts inline code in its web page or app which is supplied by the broker. The broker also pays a fee to the publisher. This may be the fee it received from the task originator minus a commission. The inline code, when executed by the user's browser or device, enables the broker to communicate with the user. The broker proceeds with identifying users who have devices that are suitable for completing the task. The task is assigned and delivered to the user device and executes on that device. When the task is completed, the task output is delivered to the broker. The broker makes the output accessible to the task originator. In these processes, the user, task originator, and publisher are anonymous to one another; their identities are protected. The broker manages the transactions and message passing among the parties and facilitates the computational resource management system. Payments are made among the task originator, broker, and publisher. The publisher realizes a non-advertising based revenue stream.

One aspect of the present invention is a method executing a task coming from a task originator by utilizing a computing device belonging to a user, where the user is engaged with a publisher by visiting a web site or using a publisher app. A broker, initially acting between the task originator and the publisher, identifies a user device available for task computation. The broker then negotiates a handshake with the user, thereby taking the publisher out of a feedback loop that goes from the user (task executor) to the task originator. The broker identifies a user computing device that would be suitable for executing the task in light of the task constraints. One requirement is that performance on the device (e.g., visiting the web site or executing an app) would not be affected by executing the task, that is, no noticeable performance degradation that would prevent the user from a normal user experience inside the website or app. Once a user is identified, the task is assigned to the user by the broker. The task executes on the user device and the output is sent to the broker. The broker then makes the output available to the task originator.

### BRIEF DESCRIPTION OF THE DRAWINGS

References are made to the accompanying drawings, which form a part of the description and in which are shown, by way of illustration, specific embodiments of the present invention:

FIG. 1 is a block diagram showing the parties in accordance with one embodiment of the present invention;

FIG. 2 is a flow diagram illustrating steps taken to implement the computational management system of the present invention;

FIG. 3 is a block diagram showing relationships between the entities before and after a “handshake” between the broker and user in accordance with one embodiment;

FIG. 4 is a flow diagram and state machine showing steps taken by the user and various user states enabling the resource management system in accordance with one embodiment;

FIG. 5 is a flow diagram showing steps taken by a publisher in accordance with one embodiment;

FIG. 6 is a flow diagram of a process taken by the task originator in accordance with one embodiment;

FIG. 7 is a block diagram showing an awaiting work units pool and a tasks pool going into a broker queuing algorithm where tasks are matched and combined with awaiting work units to create actual work performed units in accordance with one embodiment; and

FIGS. 8A and 8B are block diagrams of a computing system, such as a mobile device or a server, suitable for implementing various embodiments of the present invention.

### DETAILED DESCRIPTION OF THE INVENTION

Example embodiments of a computational resource management system are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for utilizing computing devices to perform third-party computational tasks while providing revenue for publishers, such as online content providers and app developers are described in the various figures. In the described embodiment, the computer devices are personal devices, such as home PCs, laptops, mobile phones, e-readers, and tablets. Before describing various embodiments of the present invention, it is useful to discuss the various entities or parties needed, in most cases, to implement the computational resource management system of the present invention.

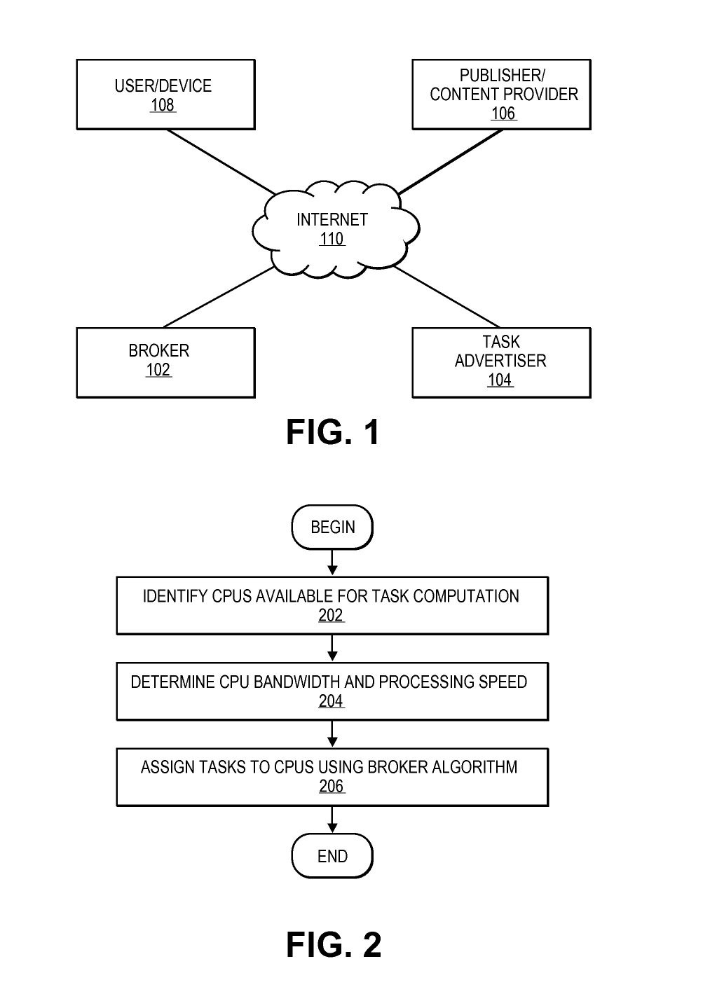

FIG. 1 is a block diagram showing the parties or entities in accordance with one embodiment of the present invention. The entity (i.e., service provider) implementing the computing resource management system is the computational resource manager, also referred to as a broker 102. Broker 102 communicates with other parties through a computer network such as the Internet 110. Broker communicates with a task originator 104. Task originator 104 has a computational task or computing project that likely requires significant CPU and memory. It may be a project that task originator 104 cannot do using its current resources and has to outsource it in some manner. As described below, it advertises, or lets it be known, to broker 102 that it has a computing project that it needs help with.

Another entity is the content publisher or app developer 106 (referred to herein as “publisher” an entity that publishes content and has users). Publisher 106 has an interest in generating revenue and may do so via advertising. It may also do so by helping task originator 104 with its computing task via broker 102. It is an entity that has content viewed or used by users (as noted, publishers can be app developers). Finally, there is user 108 who has a computer or mobile device that can be used to perform parts of the task. The term “user” may refer to either the individual or the device (or browser on the device), depending on the context. In one embodiment user 108 may be an individual but more broadly it can be any party (e.g., a small or medium size, a company, public institution, etc.), that has excess computing power on its machines. However, for ease of illustrating one embodiment, user 108 refers to an individual having a personal computer or mobile device that is available to be used for computation (as described below, it must meet certain constraints). As noted, depending on the context, user 108 may refer to an individual or the end user machine; in some cases it may be logical to equate the individual with the individual's computing device. There are other requirements, described below, for a computer or device to be eligible to participate in the computational resource management system of the present invention.

The primary goal of the present invention is to enable users 108 who visit publisher websites or who use certain apps to be data processing resources. As explained below achieving this goal leads to fulfilling another goal, that is giving a high-traffic websites and popular apps (publishers) a non-advertising based revenue channel.

In one embodiment, user 108 is an individual with an Internet-enabled computing device, such as a desktop or laptop computer, tablet, e-book reader, or mobile phone, that has a browser or any other application capable of rendering HTML and JavaScript. A publisher 106 is an entity that has an app or a website that serves web pages to end users 108, i.e., visitors to its website viewed through a browser. More, specifically, a publisher 106 serves content over HTTP/HTTPS and the content is rendered by user 108 with a program that can interpret HTML and JavaScript languages. Publisher 106 has signed up with broker 102. Upon registering with broker 102, publisher 106 receives a unique JavaScript code which it inserts into certain web site content pages where the publisher 106 wishes to generate income from this service. For example, a publisher may have subscription (paying) customers and non-subscription customers. The JavaScript code may only be inserted into the pages that the non-subscription customers access and the pages that the paying customers access may not have the inline code. In another embodiment, the publisher may have a free version of an app and a paid version. The JavaScript may only be inserted in the free version of the app. In both these embodiments, the JavaScript code (i.e., the computational resource sharing) is only utilized by non-paying users.

Task originator 104 is an entity that has a clearly defined computational task and has computer code, for example, in JavaScript, to solve the task. The task may be described as a discrete and finite problem that can be clearly expressed and formulated using a computer programming language. A task may have an input and an output, both encapsulated in a feedback loop that allows the task and task results to be integrated into existing infrastructure. Another type of task is virtualization of a computing device. Here, the user's device is booting up an operating system or platform, for example, a small Linux system. Essentially, the system enables virtualization of an entire server inside a Web browser. This gives the task originator a richer environment and one that is equivalent in terms of compatibility with popular systems and programming languages.

As noted, broker 102 provides a non-advertising revenue channel for publisher 106. One or more broker algorithms execute on any suitable platform with a web browser. In one embodiment, broker 102 uses various metrics, such as “unique visitors” and “time on website” as primary functions of revenue. As explained below, broker 102 pays publishers 106 by having the publisher's active visitors run small computational tasks for task originators which pay for computational time.

FIG. 2 is a flow diagram illustrating steps taken to implement the computational management system of the present invention. At step 202 one or more resources, specifically users with computing devices with CPUs, that are accessible and available for computation are identified. In the described embodiment, this is done by broker 102. In another embodiment, it may be performed by publisher 106. As such, the process described in FIG. 2 is entity-agnostic. At step 204 the system determines bandwidth and processing speed of the one or more identified CPUs. In determining bandwidth and processing speed, broker 104 may consider a number of factors, including geographic location, type of device, and quality of Internet connection from the user 108. From these factors, broker 102 may estimate the capability of the available CPUs.

At step 206 tasks are assigned to the one or more CPUs based on the available resources. At this stage broker 102 and other entities are ready to proceed with actual task completion and passing of output to task originator feedback loops

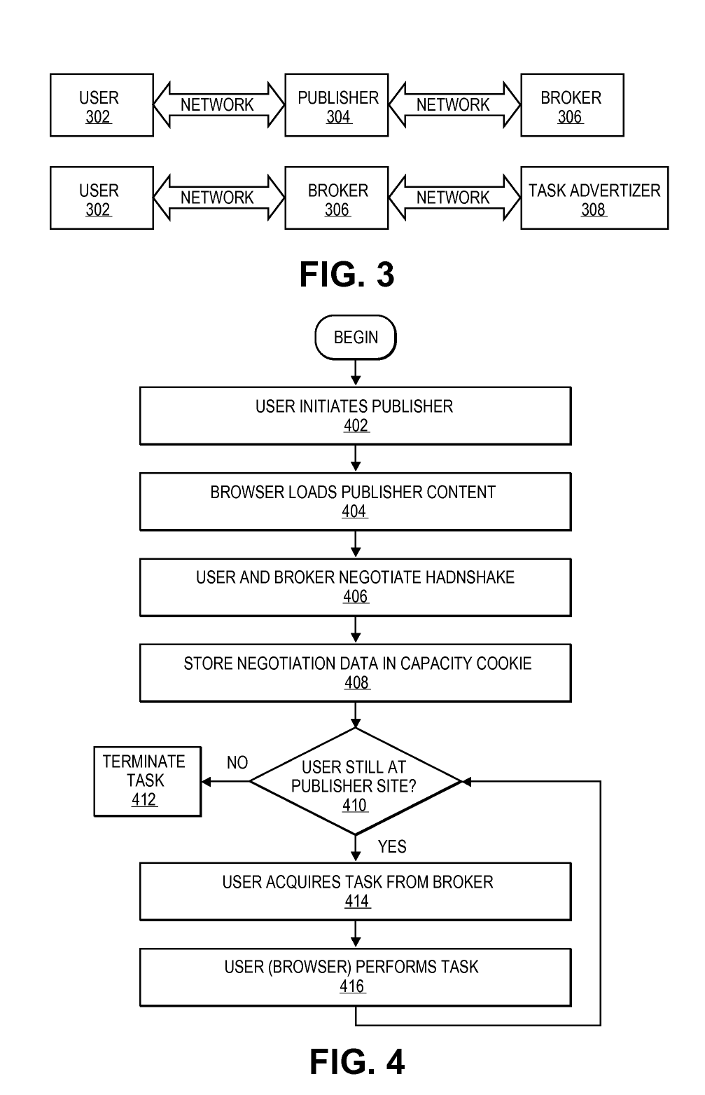

FIG. 3 is a block diagram showing relationships between the entities before and after a “handshake” between broker and user. This is a central component in the system of the present invention. The broker-user handshake occurs after step 206. Before it occurs, there is the conventional (“normal course”) relationship between user 302 and publisher 304. That is, user 302 visits pages at a publisher website, as is presently done. Broker 306 communicates with publisher 304. Once the handshake negotiation takes place between broker 306 and user 302, broker 306 begins direct communications with user 302 and with a task originator 308. Before describing the broker-user handshake negotiation it is helpful to describe characteristics of the relationships shown in FIG. 3.

In the relationship between the user, publisher and broker, a user's computational resources are only available for a task while the user is actively viewing the publisher's website, specifically the content pages designated by the publisher or while the user is using the publisher's app. When a user stops viewing content on the website or using the app, the user's resources are no longer available and task computation on that user's CPU terminates, even if the task is not complete. The user and task originator do not have any information on each other and do not communicate directly. The same is also true with respect to the publisher and task originator. The publisher does not know and does not communicate directly with the task originator and the task originator does not communicate with the publisher. The user is anonymous and fungible with another user, that is, any other user meeting the constraints for doing the same task. The user is also anonymous to broker or task originator. In another embodiment, the publisher and task originator may communicate. For example, in FIG. 2, steps 202 and 204 may be performed by a publisher (which takes on the role of broker). Computational resource management may be driven by the publisher, although likely through services provided by a resource management service provider.

In the relationship between the completed task output, which resulted from the task executed by the user and the broker, the output is piped to a broker feedback loop. In one embodiment, a collection of users available for work, who are independent, and unknown to each other, will be given the same task T from the broker. Then, one-by-one, each of these users in the user collection pool is assigned to the same task T and reports the output of task T to the broker. When this occurs, a voting algorithm is used by the broker for deciding the correctly expected output. Suppose there are N users (user collection pool) assigned to do one task T, and M report back to the broker the computed answer as the task output. In one embodiment, if more than 50% of M users arrive at a particular task output answer X, then the broker deems this subset of M users as the majority O users subset. At this stage the broker decides that the X answer is the correct task output and reports the answer as task output X back to the task originator's feedback loop for task T. In this case, N users were given the task, M users reported an answer back, but O users get a fraction of credit (1/(size of O)) for producing the correct output for task T. If the M users do not independently agree upon a majority task output answer, then all M users are deemed to be invalid and the task is given again to a different pool of users. For example, suppose 6 users are given a task of adding the numbers 1+2. Three users report the task output 3 and two report the task output 2. The broker decides that the correct task output is 3, and the result 3 is given to the feedback loop.

In the described embodiment, broker 306 manages each transactional message among the parties. These transactional messages include primarily ‘task messages’ and ‘task result messages’. All such messages pass through broker 306. The broker is in control of each transactional message and is privy to all the activity in the system.

It should be noted that the user is providing only computational resources and not any personal information (e.g., cookies, e-mail addresses, IP addresses, or any personal data inside of the device) that can be used to identify the user to the task originator. Similarly, the publisher cannot relay any personal information about the user (e.g., name, address, username, browsing habits, etc.) about the user to the task originator.

FIG. 4 is a flow diagram and state machine showing steps taken by the user and various user states enabling the resource management system in accordance with one embodiment. It describes the process from the user's perspective and a protocol followed by the user. At step 402 the user having, for example, a mobile phone loads a website with a web browser (browser) that the publisher already registered with the broker (computational resource manager). By loading the web page, the user is said to initiate a publisher. For example, the user loads a website, www.thecontentpublisher.com. The publisher of this website has registered some or all of its pages with the broker. At step 404 the user browser performs a browser translate. Here the browser loads certain pages (content) from www.thecontentpublisher.com. At least one of these pages contains an inline JavaScript, described below, which is provided by the broker to the publisher when the publisher registers with the broker. By loading this specific JavaScript, the user browser ends up running broker code. At step 406 the user and broker negotiate a handshake. The user (browser) negotiates a handshake with the broker for CPU time and upload/download bandwidth capacity. The browser may also provide the broker with geo-location and language information about the user.

Information obtained from the handshake negotiation is stored in a cookie 408 in the user's browser. This ‘capacity’ cookie allows future handshakes (with any and all publishers registered with the broker) to be faster. Once the handshake is done, there is a series of states: task decision, acquire, perform, relay, and terminate. At step 410, the system checks whether the user is still on the publisher's website (or using the publishers app). If not, control goes to step 412 where the process terminates since now the user cannot perform the work. If the user is still at the site, the state changes to task acquire at step 414. At task acquire state, the browser retrieves a task from the broker task queue. At step 416, now in task perform state, the browser or CPU performs the retrieved task. It is at this state that the device, in this case a mobile phone, begins serving as a computational resource for the task. At step 418, now in task relay state, the browser relays or communicates the output or results of the task to the broker. In other embodiments, results may be relayed to the broker at different stages of task completion. The state then returns to task decision at step 410. If the user is still on the publisher's website, the browser returns to task acquire state. If not, the session is terminated as shown at step 412 and no further tasks are retrieved.

As noted, when a publisher registers its pages with the broker, a special JavaScript code is inserted into those pages. This inline code causes the user's web browser to execute broker code. This inline code may be: <script src=“http://computationalbroker.com/broker.js”></script>. Once the JavaScript call occurs, there is a call to execute code on broker's server. At this stage the broker can talk directly to the user. The broker can have the user directly download a task to run. The user runs it and delivers the AWPU to the broker. If the user closes the browser or application, then the task terminates.

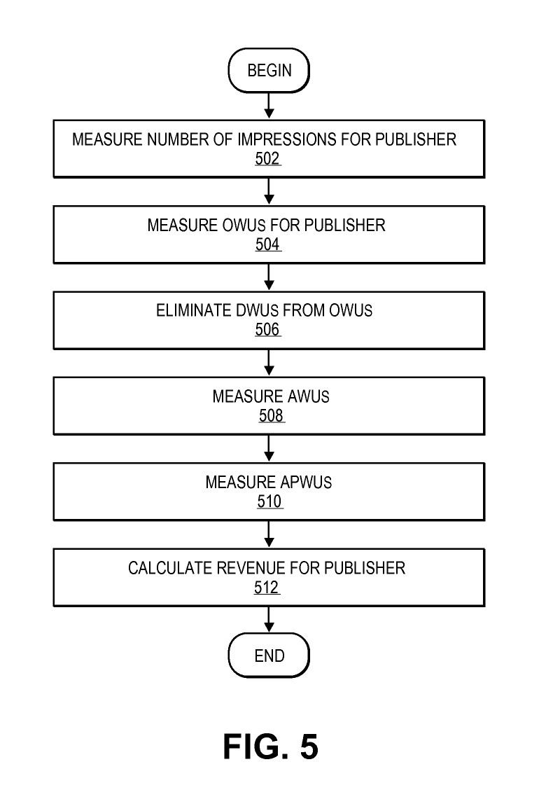

FIG. 5 is a flow diagram showing steps taken by a publisher in accordance with one embodiment. As noted above, a user will only qualify for performing a task if doing so will not degrade or effect in any way the normal user experience of viewing the publisher's website or app. The device running the browser (laptop, mobile phone, tablet, etc.) has sufficient bandwidth and CPU power to complete the task without interrupting the normal user experience. It is the broker's responsibility to make this determination. Also, as noted, once the user leaves the publisher's website or app, specifically the pages or content registered with the broker and that have the inline JavaScript (not all pages of a publisher's website may have the JavaScript), the user cannot perform any work provided by the broker.

These are important factors because publishers generate revenue as a function of actual performed work dispensed by the broker. In this regard there are several metrics or units that are maintained by the publisher and broker to determine revenue to the publisher. These metrics are used for revenue calculations. One is “impressions” 502, the total number of page impressions that are tracked with, for example, a 1×1 pixel transparent image through the broker. Another is “opportunity for work unit (OWU)” 504 which is the total number of user's who's browsers have loaded the JavaScript code and qualify for performing the task without affecting user experience. Another unit is referred to as the “disqualified work unit (DWU)” 506. These DWUs represent the total number of users who's browsers have loaded the JavaScript code but do not perform work either because of a performance-related reason or because of an opt-out available to the user provided by the publisher. Another metric is the “awaiting work unit (AWU)” 508. This unit represents the total number of users who's browsers have loaded the JavaScript, qualify for doing the work involved with the task and are, at this stage, awaiting work, but have not yet performed the work. Once the work is performed and completed, it is measured using “actual performed work unit (APWU)” 510. These are the total number of users whose browsers have loaded the JavaScript, qualify for work and have performed the work. This leads to a calculation of revenue 512 earned by the publisher, determined primarily by the number of APWUs.

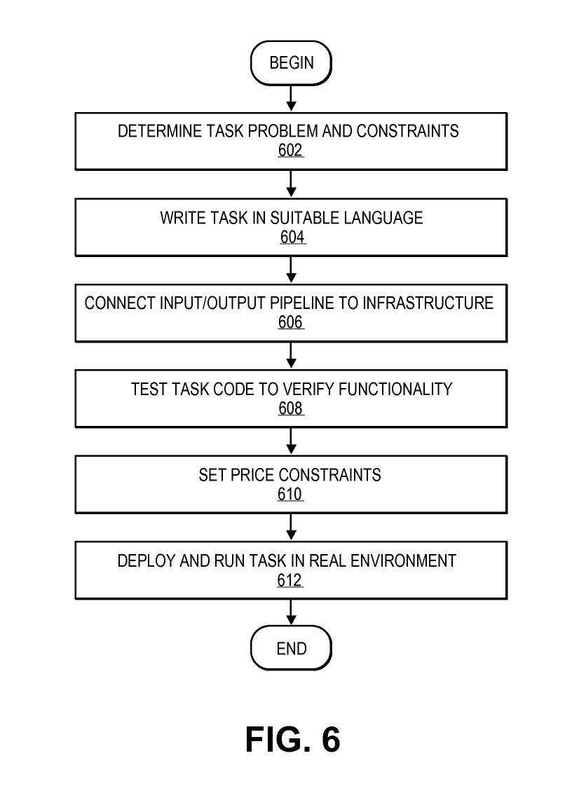

FIG. 6 is a flow diagram of a process taken by the task originator in accordance with one embodiment. At step 602 the task originator initializes a set of discrete constraints of the task. At step 604 the task is expressed in the JavaScript language by the task originator or is a virtualized computing machine containing a task written in an alternate language. At step 606 an input and output pipeline to the infrastructure is created which allows the completed task result to be piped through the broker and into a data structure. The task originator may then retrieve the task results by accessing the data structure. In another embodiment, the task output is pushed or delivered directly to the task originator. The task is connected to input and output pipelines for integration into an existing infrastructure. At step 608 the task originator creates a test system to verify functionality of the task. At step 610 the task originator sets price constraints. This is the amount of money the task originator is willing to spend and the approximate number of tasks the task originator wants to have completed.

The broker uses one or more algorithms for executing steps in FIG. 2. One of the algorithms involves gathering intelligence from the user's browser including the manufacture (such as Google, Apple, Mozilla, Microsoft), the browser product name (such as Chrome, Safari, Firefox, Internet Explorer), the device type (such as desktop, laptop or mobile device), the battery life (if applicable), device capabilities such as persistent storage and other HTML5 capabilities, and lastly analyzing the device connection type (such as dial-up, broadband, mobile broadband, dedicated connection) which also reveals the geographic location based on IP address. Each of the other parties (users, publisher, and task originator) have respective inputs and outputs with respect to the algorithm. In one embodiment, user input includes AWUs and output includes APWUs. Publisher input includes multiple AWUs (from the broker). Output or what is gained is revenue collected from the task originators for APWUs. The input from task originators is new tasks and payment for task completion. What is gained is the results from completed tasks.

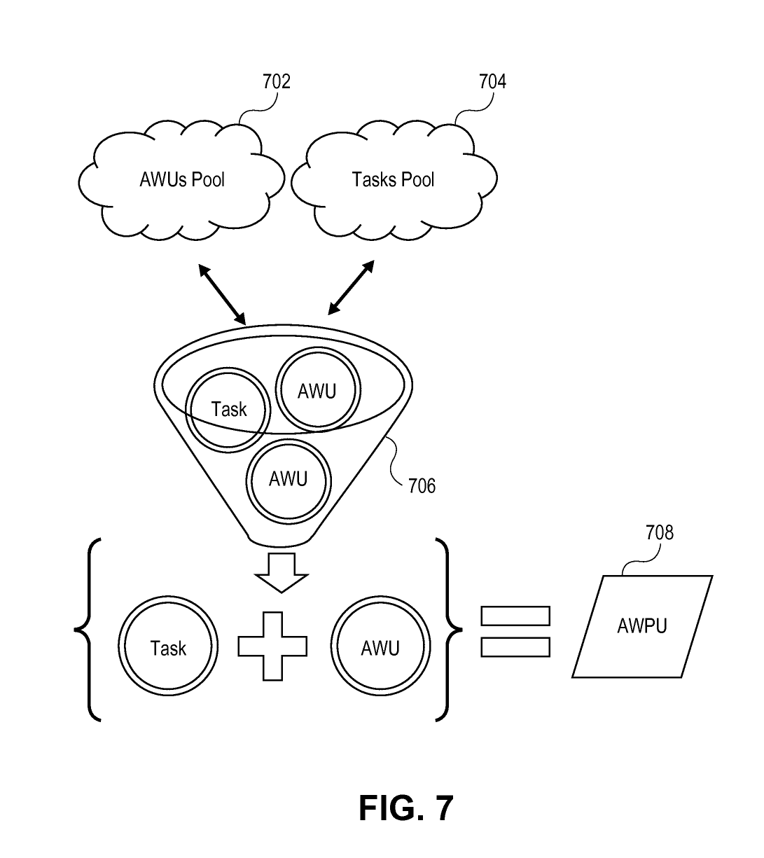

In one embodiment the broker also uses a queuing algorithm. At a high level, a broker queuing algorithm matches and combines tasks and AWUs to produce AWPUs. The tasks are matched to AWUs with the Task/AWU matching algorithm. FIG. 7 is a block diagram showing an AWU pool 702 and a Tasks pool 704 going into a broker queuing algorithm 706 where tasks are matched and combined with AWUs to create AWPUs 708. A task is matched with AWUs using the broker matching algorithm. A broker queuing algorithm matches tasks to AWUs to produce the best outcome for the task originator and the maximum revenue for the publisher. In one embodiment, a broker queue algorithm matches tasks to AWUs to produce the best outcome for the task originator. It also maximizes revenue for the publisher.

An AWU may be comprised of user device capacity, such as CPU, memory, and thread capacity. Another factor that may be considered is bandwidth, namely upload and download speed measured in kilobytes per second and latency time communication between the user and the broker measured in milliseconds. Yet another factor examines data on past task completion and similar metrics, which may include percentage of prior completions, high CPU tasks, high memory tasks, total AWU and AWPUs, and average time of an AWU in last n days or during a certain period. Another factor is customer loyalty, such as the amount of money spent by the customer and total number of tasks executed.

As noted above, the computer resource management system provides a revenue stream for the publisher and broker. There are exchanges of consideration between the parties. Starting with the broker, it receives payment, a defined task, and software code to solve the task. With respect to payment from the task originator, in one embodiment, the broker keeps a brokerage fee from that payment and the balance goes to the publisher. The publisher of the website provides its content to the end user. It may provide it for free, without ads, with ads, or with a fee. The user performs the task by using any unused computational resources on his or her device. The publisher makes these computational cycles available to the broker. The broker transmits results from the completed task to the task originator. The step to note here is the payment from the task originator to the broker. In one embodiment, this is a pre-requisite to having the task completed. Once the broker receives the payment, it passes the task to the publisher in a task message. It keeps a brokerage fee and pays the publisher the remainder of the payment for having the task completed. Solutions to the task are transmitted to the task originator in consideration for the payment.

The algorithm checks to see if the user is on a computer or device that can handle this task. It also considers geographic location or geo-location of the user, device type, and network connection type. All this information is catalogued this way.

With virtualization, it is efficient to match a task with a CPU because it is easier to see what is needed when running an entire platform, such as a Linux machine. In contrast, running a task, essentially a piece of code, the system needs to see what the code needs in order to find a compatible device. This requires more work on behalf of the broker.

It is worth noting that the publisher has discretion as to which users will be used to perform a task, as long as the user is from the list of users that are available, accessible, and have suitable devices, connectivity, etc. for the task. Users can be informed through the publisher's privacy policy of the resource sharing and the publisher can provide an opt-out mechanism for users who do not want to participate.

Task output is a message which contains the results from a completed task. For example, if the task is adding the numbers 1+2, task output calculated by the user is 3, and this message (“3”) is encapsulated to an embedded feedback loop provided by the broker which delivers the message or task output to the task originator in a data structure accessible by the task originator. It is important for the broker to get the definition of the task output from task originator. A task can be one or more AWUs and is a finite state machine that can be broken up into many state AWUs.

Task originators' tasks are prioritized based on task originator metrics, but each task is still considered independently. However, keeping in mind that the ultimate goal is to generate maximum revenue for the publishers and broker, the tasks are prioritized accordingly. So, combination of metrics, stand-alone factors, and revenue maximization is used to prioritize tasks.

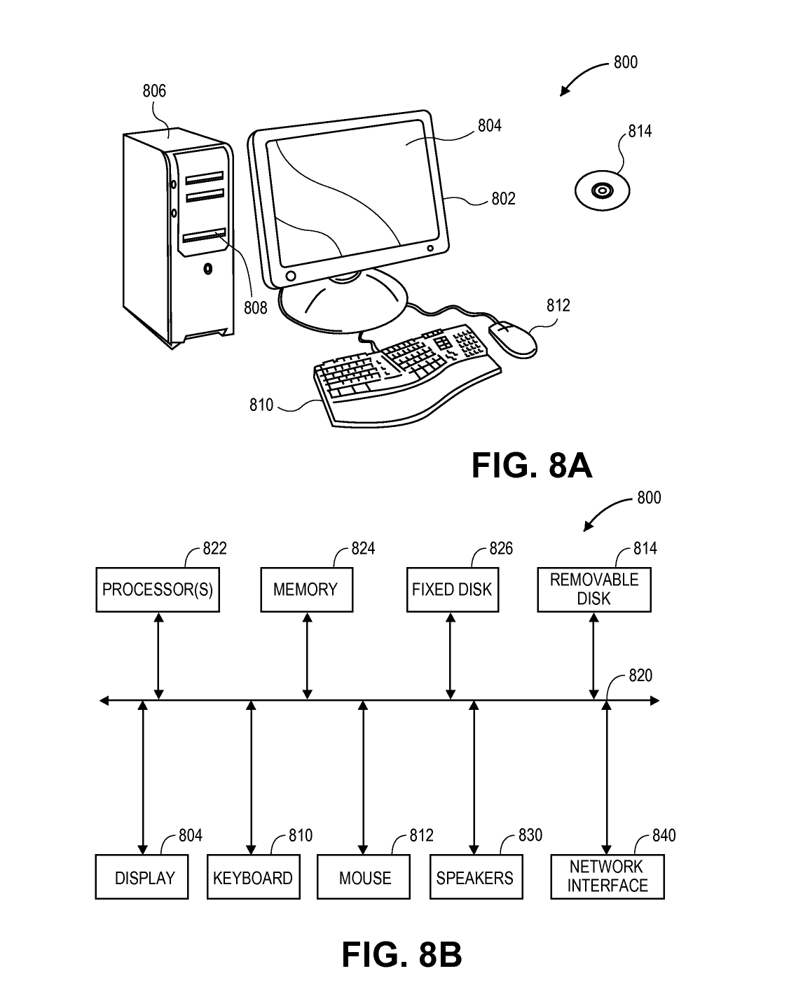

FIGS. 8A and 8B illustrate a computing system 800 suitable for implementing embodiments of the present invention. FIG. 8A shows one possible physical form of the computing system. Of course, the computing system may have many physical forms including a small handheld device, such as a mobile phone or tablet. Computing system 800 includes a monitor 802, a display 804, a housing 806, a disk drive 808, a keyboard 810 and a mouse 812. Disk 814 is a computer-readable medium used to transfer data to and from computer system 800.

FIG. 8B is an example of a block diagram for computing system 800. Attached to system bus 820 are a wide variety of subsystems. Processor(s) 822 (also referred to as central processing units, or CPUs) are coupled to storage devices including memory 824. Memory 824 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 826 is also coupled bi-directionally to CPU 822; it provides additional data storage capacity and may also include any of the computer-readable media described below. Fixed disk 826 may be used to store programs, data and the like and is typically a secondary storage medium (such as a hard disk) that is slower than primary storage. It will be appreciated that the information retained within fixed disk 826, may, in appropriate cases, be incorporated in standard fashion as virtual memory in memory 824. Removable disk 814 may take the form of any of the computer-readable media described below.

CPU 822 is also coupled to a variety of input/output devices such as display 804, keyboard 810, mouse 812 and speakers 830. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 822 optionally may be coupled to another computer or telecommunications network using network interface 840. With such a network interface, it is contemplated that the CPU might receive information from the network, or might output information to the network in the course of performing the above-described method steps. Furthermore, method embodiments of the present invention may execute solely upon CPU 822 or may execute over a network such as the Internet in conjunction with a remote CPU that shares a portion of the processing.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

I claim:

1. A method of executing a computational task utilizing a computing device, the method comprising:
identifying a device available for task computation;
negotiating a handshake with the device;
determining whether device performance will be affected by task execution; and
assigning the task to be completed to the device.

2. A method as recited in claim 1 further comprising:
combining the task with an available work unit, wherein the available work unit is constructed using computing device data including CPU data, memory data, thread data, bandwidth, latency to service provider, and geographic location.

3. A method as recited in claim 1 wherein computing device performance includes user experience of viewing a Web site.

4. A method as recited in claim 1 further comprising:
determining if the device is no longer being used to view a Web site.

5. A method as recited in claim 2 wherein the available work unit is constructed from past task completion metrics for the computing device, including percentage of prior completion of tasks by the computing device.

6. A method as recited in claim 1 wherein a task is characterized by task requirements, speed requirements, and customer loyalty.

7. A method as recited in claim 1 further comprising:
disqualifying a computing device because of work performance.

8. A method as recited in claim 1 further comprising:
receiving a task from a task originator; and
receiving revenue from the task originator.

9. A method as recited in claim 1 further comprising:
maintaining a task queue that is accessible by the device.

10. A method as recited in claim 1 further comprising:
communicating with a publisher by negotiating the handshake with a user of the computing device.

11. A method as recited in claim 1 further comprising:
transmitting an executable instruction to the publisher for insertion in a publisher web page.

12. A method as recited in claim 1 further comprising:
transmitting an executable instruction to the publisher for insertion in a publisher app.

13. A method as recited in claim 1 further comprising:
collecting computing device browser data including manufacturer and name; and
collecting computing device data including type, capabilities, and connection type.

14. A method as recited in claim 1 wherein the task is a virtualized computing device.

15. A method as recited in claim 1 further comprising:
maintaining a task output data structure accessible by the task originator.

16. A method as recited in claim 1 further comprising:
calculating revenue for the publisher; and
measuring impression count for publisher.

17. A method of executing a task using a service provider and publisher, the method comprising:
initializing constraints of the task;
creating the task in a suitable programming language;
connecting to a service provider to enable transmission and receipt of task messages;
determining price constraints for executing the task; and
transmitting the task to a service provider.

18. A method as recited in claim 17 further comprising:
verifying functionality of the task by executing the task on a task originator system.
